(19) United States
(12) Patent Application Publication
(10) Pub. No.: US 2015/0153870 A1
(43) Pub. Date: Jun. 4, 2015

(54) TOUCHSCREEN DEVICE AND METHOD OF SENSING TOUCH

(71) Applicant: SAMSUNG ELECTRO-MECHANICS CO., LTD., Suwon (KR)

(72) Inventors: Hyun Suk LEE, Suwon (KR); Ji Hoon KIM, Suwon (KR); Na Rae PARK, Suwon (KR)

(73) Assignee: SAMSUNG ELECTRO-MECHANICS CO., LTD., Suwon (KR)

(21) Appl. No.: 14/164,644

(22) Filed: Jan. 27, 2014

(30) Foreign Application Priority Data
Nov. 29, 2013 (KR) 10-2013-0147661

(51) Int. Cl. G06F 3/044

(52) U.S. Cl. CPC G06F 3/044

(57) ABSTRACT

There are provided a touchscreen device and a method of sensing a touch. The touchscreen device includes: a subtraction unit, for all sensing signals acquired from a plurality of electrodes, obtaining differences in levels between the sensing signals acquired from two adjacent electrodes; a region determination unit determining touched regions and untouched regions based on difference signals generated in the subtraction unit; an average unit calculating an average of levels of the sensing signals generated in the plurality of electrodes determined as the untouched regions to generate a noise estimation signal; and a noise removal unit subtracting a level of the noise estimation signal from the levels of the sensing signals.

### CROSS-REFERENCE TO RELATED APPLICATION

This application claims the benefit of Korean Patent Application No. 10-2013-0147661 filed on Nov. 29, 2013, with the Korean Intellectual Property Office, the disclosure of which is incorporated herein by reference.

### BACKGROUND

The present disclosure relates to a touchscreen device and a method of sensing a touch.

A touch sensing device such as a touchscreen or a touch pad is attached to a display device to provide an intuitive method of data input to a user and has recently been widely applied to various electronic devices such as cellular phones, personal digital assistants (PDA) and navigation devices. In particular, as demand for smartphones has increased recently, touchscreens have been increasing used as touch sensing devices able to provide users with various methods of data input in a limited form factor.

Touchscreens used in portable devices may mainly be divided into resistive type touchscreens and capacitive type touchscreens, depending on the manner in which a touch is sensed. Among these, capacitive type touchscreens have advantages of a relatively long lifespan and ease of implementation of various data input touches and gestures, and thus capacitive type touchscreens have been increasingly employed. Implementation of a multi-touch interface is especially easy in capacitive type touchscreens, as compared to resistive type touchscreens, and thus capacitive type touchscreens are widely used in smartphones and the like.

Capacitive type touchscreens include a plurality of electrodes having a predetermined pattern, the electrodes defining a plurality of nodes in which changes in capacitance are generated due to touches. The nodes deployed in a two-dimensional plane generate changes in self-capacitance or mutual-capacitance by a touch. Coordinates of the touch may be calculated by applying a weighted average method or the like to the change in the capacitance generated at the nodes.

In order to accurately calculate coordinates of a touch, changes in capacitance generated by a touch need to be accurately sensed. However, when electrical noise arises in a wireless communications module, a display device or the like, changes in capacitance may not be accurately sensed.

### RELATED ART DOCUMENT

(Patent Document 1) Korean Patent Laid-Open Publication No. 2011-0137482

### SUMMARY

An aspect of the present disclosure may provide a touchscreen device and a method of sensing a touch which generates difference signals by obtaining differences in levels between sensing signals or between digital signals acquired from adjacent electrodes, and calculates a noise level by calculating an average level of the sensing signals or of the digital signals from which difference signals within a predetermined level section originate.

According to an aspect of the present disclosure, a touchscreen device may include: a subtraction unit, for all sensing signals acquired from a plurality of electrodes, obtaining differences in levels between the sensing signals acquired from two adjacent electrodes; a region determination unit determining touched regions and untouched regions based on difference signals generated in the subtraction unit; an average unit calculating an average of levels of the sensing signals generated in the plurality of electrodes determined as the untouched regions to generate a noise estimation signal; and a noise removal unit subtracting a level of the noise estimation signal from the levels of the sensing signals.

The region determination unit may determine electrodes of the plurality of electrodes from which difference signals within a predetermined level section among the difference signals are originated as the untouched regions and determining electrodes of the plurality of electrodes from which difference signals out of the predetermined level section among the difference signals are originated as the touched regions.

The predetermined level section may be below a first level in a positive direction and above a second level in a negative direction with respect to a zero level.

The level of the noise estimation signal applied to the sensing signals acquired in the touched regions by the noise removal unit may be different from that of the untouched region.

The noise removal unit may increase the level of the noise estimation signal in proportion to amplitudes of the sensing signals acquired in the touched regions and subtract the increased level of the noise estimation signal from the levels of the sensing signals acquired in the touched regions.

According to another aspect of the present disclosure, a touchscreen device may include: a panel unit including a plurality of first electrodes and a plurality of second electrodes intersecting the plurality of first electrodes; a driving circuit unit applying driving signals to the plurality of first electrodes; a sensing circuit unit acquiring sensing signals from the plurality of second electrodes; and a control unit generating difference signals by obtaining differences in levels between sensing signals from two adjacent electrodes for all sensing signals acquired from the plurality of second electrodes, and determining whether a touch has occurred based on a noise level calculated based on difference signals within a predetermined level section among the difference signals.

The sensing circuit unit may include a plurality of C-V converters detecting capacitance values generated in intersections of the plurality of first electrodes and the plurality of second electrodes as voltage.

The plurality of C-V converters may integrate the capacitance values to detect them as voltage.

The control unit may include: a signal conversion unit converting sensing signals from the plurality of second electrodes into digital signals; a noise calculation unit generating difference signals by obtaining differences in levels between the digital signals generated in every two adjacent electrodes of the plurality of second electrodes, and calculating a noise estimation signal based on difference signals within a predetermined level section among the difference signals; and a noise removal unit subtracting a level of the noise estimation signal from the sensing signals acquired from the plurality of second electrodes.

The touchscreen device may further include: a touch determination unit determining whether a touch has occurred based on an effective signal generated by the noise removal unit.

The noise calculation unit may include: a subtraction unit generating difference signals by obtaining differences in levels between digital signals generated in every two adjacent electrodes of the plurality of second electrodes; a region determination unit determining touched regions and untouched regions based on the difference signals; and an average unit generating the noise estimation signal by calculating an average of levels of digital signals of the plurality of second electrodes determined as the untouched regions.

The region determination unit may determine electrodes of the plurality of second electrodes from which difference signals within a predetermined level section among the difference signals are originated as the untouched regions and determining electrodes of the plurality of second electrodes from which difference signals out of the predetermined level section among the difference signals are originated as the touched regions.

The noise removal unit may apply the noise estimation signal without changing a level thereof to the digital signals acquired in the untouched regions whereas applies the noise estimation signal with the level changed to the digital signals acquired in the touch regions.

The noise removal unit may increase the level of the noise estimation signal in proportion to amplitudes of the digital signals acquired in the touched regions and subtracts the increased level of the noise estimation signal from the levels of the digital signals acquired in the touched regions.

The touch determination unit may determine at least one of the locations of touches, the amount of touches, and the types of gesture of the touches based on the effective signal.

According to another aspect of the present disclosure, a method of sensing a touch may include: acquiring sensing signals from a plurality of electrodes; converting the sensing signals into digital signals; generating difference signals by obtaining differences in levels between digital signals generated in two adjacent electrodes for all of the digital signals generated in the plurality of electrodes; determining touched regions and untouched regions based on the difference signals; generating a noise estimation signal by calculating an average of the digital signals generated in the untouched region; and subtracting a level of the noise estimation signal from the levels of the digital signals.

The determining of the touched regions and the untouched regions may include determining electrodes of the plurality of electrodes from which difference signals within a predetermined level section among the difference signals originate as the untouched regions and determining electrodes of the plurality of electrodes from which difference signals out of the predetermined level section among the difference signals originate as the touched regions.

The subtracting may include applying the noise estimation signal to the digital signals in the untouched region without changing a level thereof while applying the noise estimation signals to the digital signals in the touch region with the level thereof changed.

The subtracting may include subtracting the noise estimation signal with the level increased in proportion to amplitudes of the digital signals in the touched regions from the digital signals in the touched regions.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating an appearance of an electronic device including a touchscreen device according to an exemplary embodiment of the present disclosure;

FIG. 2 is a view of a panel unit included in a touchscreen device according to an exemplary embodiment of the present disclosure;

FIG. 3 is a cross-sectional view of a panel unit included in a touchscreen device according to an exemplary embodiment of the present disclosure;

FIG. 4 is a diagram illustrating a touchscreen device according to an exemplary embodiment of the present disclosure;

FIG. 5 is a block diagram of a control unit according to an exemplary embodiment of the present disclosure;

FIGS. 6A through 6C are graphs of signals output from main units of a control unit according to an exemplary embodiment of the present disclosure; and

FIGS. 7A and 7B are graphs illustrating simulation results of a touchscreen device according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

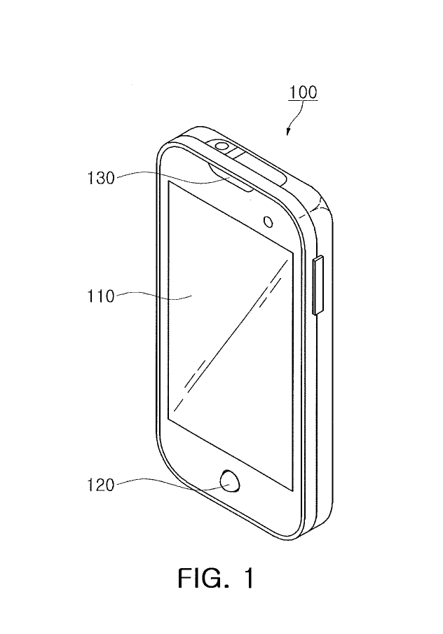

FIG. 1 is a perspective view illustrating an appearance of an electronic device including a touchscreen device according to an exemplary embodiment of the present disclosure.

As shown in FIG. 1, it is common in mobile devices that a touchscreen device is integrated with a display device, and such a touchscreen device needs to have a sufficient degree of light transmittance to allow an image displayed on the display device to be viewed by a user. Therefore, the touchscreen device may be implemented by forming a sensing electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephthalate (PET), polycarbonate (PC), polyethersulfone (PES), polyimide (PI), polymethylmethacrylate (PMMA), or the like. The display device may include a wiring pattern disposed in a bezel region thereof, in which the wiring pattern is connected to the sensing electrode formed of the transparent and conductive material. Since the wiring pattern is hidden by the bezel region, it may be formed of a metal such as silver (Ag) or copper (Cu).

Since the touchscreen device according to the exemplary embodiment is of a capacitive type, the touchscreen device may include a plurality of electrodes having a predetermined pattern. Further, the touchscreen device may include a capacitance sensing circuit to sense changes in the capacitance generated in the plurality of electrodes, an analog-digital conversion circuit to convert an output signal from the capacitance sensing circuit into a digital value, and an operation circuit to determine whether a touch has occurred using the data converted into digital value.

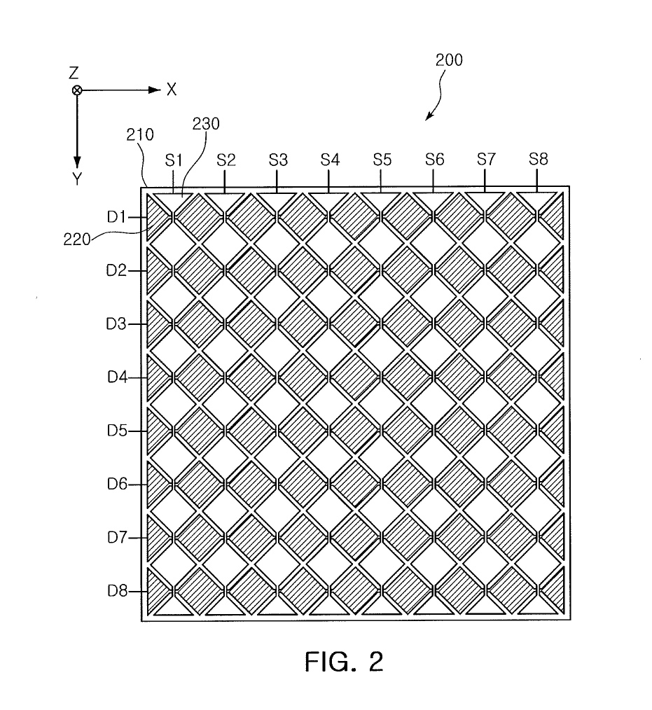

FIG. 2 is a view of a panel unit included in a touchscreen device according to an exemplary embodiment of the present disclosure.

Referring to FIG. 2, the panel unit 200 according to the exemplary embodiment includes a substrate 210 and a plurality of electrodes 220 and 230 provided on the substrate 210. Although not shown in FIG. 2, each of the plurality of electrodes 220 and 230 may be electrically connected to a wiring pattern on a circuit board attached to one end of the substrate 210 through wiring and a bonding pad. The circuit board may have a controller integrated circuit mounted thereon so as to detect sensing signals generated in the plurality of electrodes 220 and 230 and may determine whether a touch has occurred based on the detected sensing signals.

The plurality of electrodes 220 and 230 may be formed on one surface or both surfaces of the substrate 210. Although the plurality of electrodes 220 and 230 are shown to have a lozenge-shaped pattern or diamond-shaped pattern in FIG. 2, it is apparent that the plurality of electrodes 220 and 230 may have patterns having a variety of polygonal shapes such as rectangular and triangular patterns.

The plurality of electrodes 220 and 230 may include first electrodes 220 extending in the x-axis direction, and second electrodes 230 extending in the y-axis direction. The first electrodes 220 and the second electrodes 230 may be provided on both surfaces of the substrate 210 or may be provided on different substrates 210 such that they may intersect with each other. If all of the first electrodes 220 and the second electrodes 230 are provided on one surface of the substrate 210, an insulating layer may be partially formed at intersection points between the first electrodes 220 and the second electrodes 230. In the regions in which wirings connecting to the plurality of electrodes 220 and 230 are provided, other than the regions in which the plurality of electrodes 220 and 230 are formed, a printed region may be formed in the region of the substrate 210 so as to hide the wiring typically formed of an opaque metal.

A device, which is electrically connected to the plurality of electrodes 220 and 230 to sense a touch, detects changes in capacitance generated in the plurality of electrodes 220 and 230 by a touch to sense the touch, based on the detected change in capacitance. The first electrodes 220 may be connected to channels defined as D1 to D8 in the controller integrated circuit to receive predetermined driving signals, and the second electrodes 230 may be connected to channels defined as S1 to S8 to be used by the touchscreen device to detect a sensing signal.

Here, the controller integrated circuit may detect changes in mutual-capacitance generated between the first and second electrodes 220 and 230 as the sensing signal, in a such manner that the driving signals are sequentially applied to the first electrodes 220 and changes in the capacitance is simultaneously detected from the second electrodes 230.

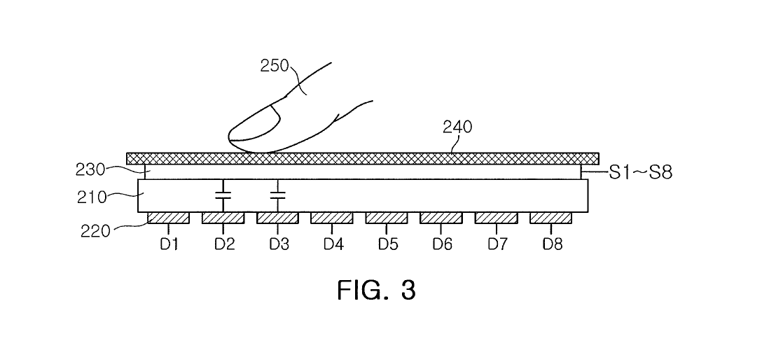

FIG. 3 is a cross-sectional view of a panel unit included in a touchscreen device according to an exemplary embodiment of the present disclosure. FIG. 3 is a cross-sectional view of the panel unit 200 illustrated in FIG. 2 taken in the y-z plane, in which the panel unit 200 may further include a cover lens 240 that is touched, in addition to the substrate 210 and the plurality of sensing electrodes 220 and 230 described above. The cover lens 240 may be provided on the second electrodes 230 used in detecting sensing signals to receive a touch from a touching object 250 such as a finger.

When driving signals are sequentially applied to the first electrodes 220 through the channels D1 to D8, mutual-capacitance is generated between the first electrodes 220, to which the driving signals are applied, and the second electrodes 230. When the driving signals are sequentially applied to the first electrodes 220, a change has occurred in the mutual-capacitance generated between the first electrode 220 and the second electrodes 230 around the area the touching object 250 comes into contact with. The change in the mutual-capacitance may be proportional to the area of the region on which the first electrodes 220, with which the touching object 250 comes into contact with and to which the driving signals are applied, and the second electrodes 230 overlap. In FIG. 3, the mutual-capacitance generated between the first electrodes 220 connected to channels D2 and D3, respectively, and the second electrodes 230 is influenced by the touching object 250.

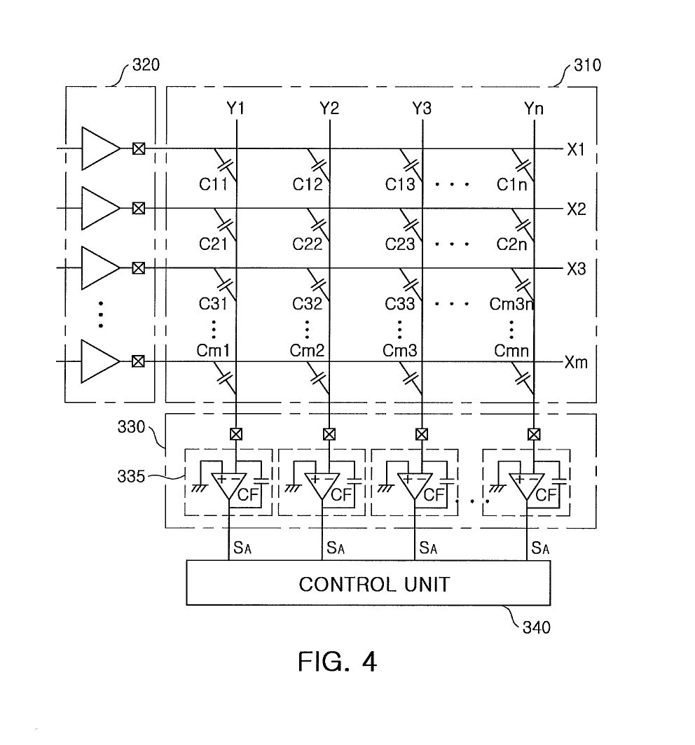

FIG. 4 is a diagram illustrating a touchscreen device according to an exemplary embodiment of the present disclosure. Referring to FIG. 4, the touchscreen device according to the present disclosure may include a panel unit 310, a driving circuit unit 320, a sensing circuit unit 330, and a control unit 340. The driving circuit unit 320, the sensing circuit unit 330, and the control unit 340 may be implemented as a single integrated circuit (IC).

The panel unit 310 may include rows of first electrode X1 to Xm extending in a first axis direction (that is, the horizontal direction of FIG. 4), and columns of second electrodes Y1 to Yn extending in a second axis direction (that is, the vertical direction of FIG. 4) crossing the first axis direction. Node capacitors C11 to Cmn are the equivalent representation of mutual capacitance generated in intersections of the first electrodes X1 to Xm and the second electrodes Y1 to Yn.

The driving circuit unit 320 may apply predetermined driving signals to the first electrodes X1 to Xm of the panel unit 310. The driving signals may be square wave signals, sine wave signals, triangle wave signals or the like having a specific frequency and an amplitude and may be sequentially applied to the plurality of first electrodes. Although FIG. 4 illustrates that circuits for generating and applying the driving signals are individually connected to the plurality of first electrodes X1 to Xm, it is apparent that a single driving signal generating circuit may be used to apply the driving signals to the plurality of first electrodes by employing a switching circuit. In addition, the driving circuit unit 320 may apply driving signals to all of the first electrodes simultaneously or to only some of the first electrodes selectively, to simply determine whether a touch has occurred.

The sensing circuit unit 330 may detect capacitance of the node capacitors C11 to Cmn from the second electrodes Y1 to Yn so as to create sensing signals S_{A}. The sensing circuit unit 330 may include C-V converters 335, each of which has at least one operation amplifier and at least one capacitor and is connected to the respective second electrodes Y1 to Yn.

The C-V converters 335 may convert the capacitance of the node capacitors C11 to Cmn into voltage signals. For example, each of the C-V converters 335 may include an integration circuit to integrate capacitance values and convert them into voltages.

Although each of the C-V converters 335 shown in FIG. 4 has a capacitor CF connected between the inverting input and the output of an operation amplifier, it is apparent that the circuit configuration may be altered. Moreover, each of the C-V converters 335 shown in FIG. 4 has one operational amplifier and one capacitor, it may have a number of operational amplifiers and capacitors to convert capacitance into a voltage and output the voltage.

When driving signals are applied to the first electrodes X1 to Xm sequentially, capacitance may be detected simultaneously from the second electrodes, the number of required C-V converters 335 is equal to the number of the second electrodes Y1 to Yn, i.e., n.

The control unit 340 may determine whether a touch has occurred on the panel unit 310 based on sensing signals S_{A} provided from the sensing circuit unit 330. Typically in a capacitive type touchscreen device, a region touched by a conductive object has less capacitance than other region not touched. The control unit 340 may determine whether a touch has occurred based on such changes in capacitance.

According to an exemplary embodiment of the present disclosure, the control unit 340 may determine at least one of the amount of touches, the coordinates of touches, and the types of gestures of the touches.

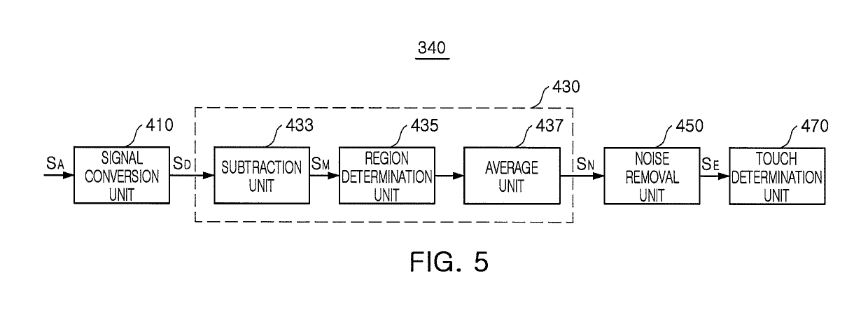

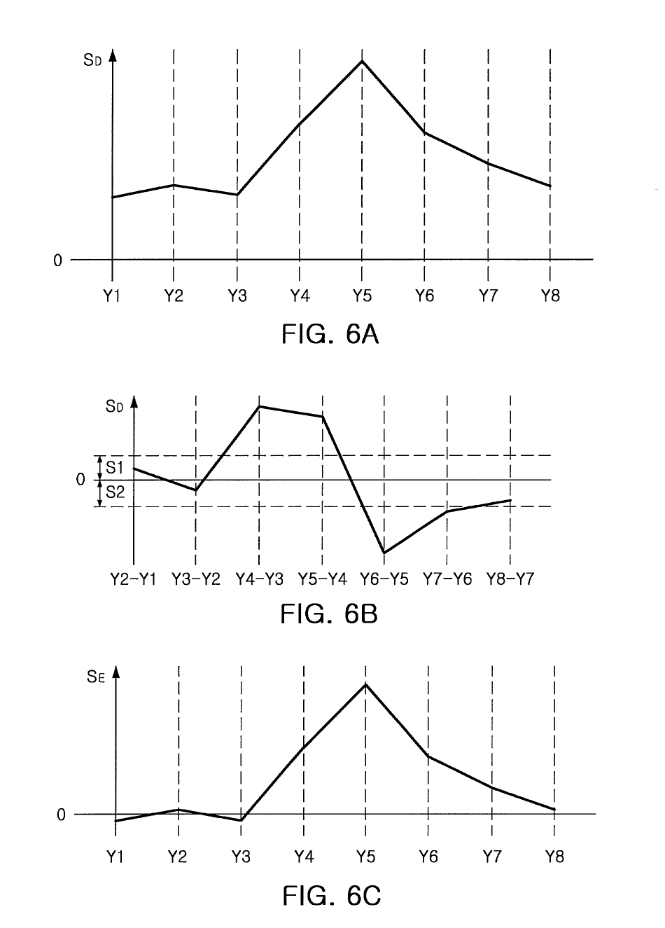

FIG. 5 is a block diagram of a control unit according to an exemplary embodiment of the present disclosure; and FIGS. 6A through 6C are graphs of signals output from main units of a control unit according to an exemplary embodiment of the present disclosure. Hereinafter, a method of sensing touches by a touchscreen device according to the exemplary embodiment will be described with reference to FIGS. 5 and 6A through 6C.

The control unit 340 according to the exemplary embodiment may include a signal conversion unit 410, a noise calculation unit 430, a noise removal unit 450, and a touch determination unit 470.

The signal conversion unit 410 may generate digital signals S_{D} based on sensing signals S_{A} generated in the sensing circuit unit. For example, the signal conversion unit 410 may include a time to digital converter (TDC) circuit measuring a time in which the sensing signals in the form of voltage output from the sensing circuit unit 330 reach a predetermined reference voltage level to convert the measured time into the digital signals S_{D}, or an analog to digital converter (ADC) circuit measuring an amount by which a level of the sensing signals in the form of voltage is changed for a predetermined time to convert the changed amount into the digital signals S_{D}.

Assuming that the sensing circuit unit 340 detects capacitance values from the second electrodes Y1 to Y7 to generate seven sensing signals S_{A}, the signal conversion unit 410 may generate digital signals S_{D} as shown in FIG. 6A, for example. In this example, it may be determined that a touch has occurred in the fourth, fifth and sixth second electrodes Y4, Y5 and Y6 of the second electrodes where the digital signals S_{D} having higher levels exist.

The noise calculation unit 430 may include a subtraction unit 433, a region determination unit 435, and an average unit 437 and may calculate a noise component possibly introduced into the panel unit, especially a common noise component, based on the digital signal S_{D} provided from the signal conversion unit 410.

The subtraction unit 433 may receive the digital signal S_{D} from the signal conversion unit 410 and may obtain differences in levels of the digital signal S_{D} between the adjacent second electrodes, to thereby generate a difference signals S_{M}. The subtraction unit 433 may obtain differences in levels between the digital signals S_{D} from adjacent second electrodes in a direction. For example, when digital signals S_{D} as shown in FIG. 6A are generated in the signal conversion unit 410, differences in levels between the digital signals S_{D} are obtained in the direction so that difference signals S_{M} as shown in FIG. 6B may be generated.

The region determination unit 435 may determine an untouched region and a touched region based on the difference signals S_{M} provided from the subtraction unit 433. Specifically, the region determination unit 435 may determine, as the untouched region, some of the second electrodes from which difference signals S_{M} within a predetermined level section among the difference signals S_{M} originate, and may determine, as the touched regions, the other second electrodes. The predetermined level section refers to a section below a first reference level S1 in a positive level direction and above a second reference level S2 in a negative level direction with respect to a zero level.

For example, for the difference signals S_{M} shown in FIG. 6B, the sections of the difference signal S_{M} below the first reference level S1 in the positive level direction and above the second reference level S2 in the negative level direction with respect to the zero level are generated by the digital signals S_{D} generated in the first, the second, the third, the seventh and the eighth second electrodes Y1, Y2, Y3, Y7 and Y8 of the second electrodes. Accordingly, the region determination unit 435 may determine the first, the second, the third, the seventh and the eighth second electrodes Y1, Y2, Y3, Y7 and Y8 of the second electrodes as the untouched region and the fourth, the fifth and the sixth second electrodes Y4, Y5 and Y6 of the second electrodes as the touched region.

The average unit 437 may calculate the average of the levels of the digital signal S_{D} in the untouched region determined by the region determination unit 435 to generate a noise estimation signal S_{N}. The untouched region refers to a region on which no touch has occurred, and thus it may be regarded that the levels of the digital signals S_{D} generated in the untouched region are generated due to common noise.

Therefore, the average unit 437 may calculate the average of the levels of the digital signal S_{D} in the untouched region to calculate the level of the common noise.

The noise removal unit 450 may generate an effective signals S_{E} based on the digital signal S_{D} provided from the signal conversion unit 410 and on the noise estimation signal S_{N} provided from the noise calculation unit 430. Specifically, the noise removal unit 450 may subtract the levels of the noise estimation signal S_{N} from the levels of the digital signals Sₚ to generate the effective signal SE.

For example, if the levels of the noise estimation signal S_{N} are removed from the digital signals S_{D} as shown in FIG. 6A, the noise removal unit 450 may generate the effective signals S_{E} as shown in FIG. 6C.

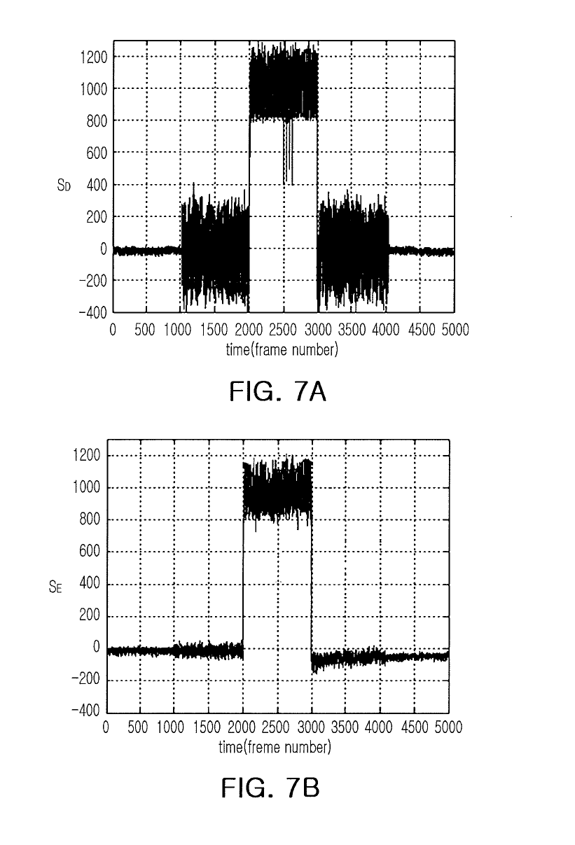

FIGS. 7A and 7B are graphs illustrating simulation results of a touchscreen device according to an exemplary embodiment of the present disclosure. FIG. 7A shows time-varying characteristics of the digital signal, and FIG. 7B shows time-varying characteristics of the effective signal. In FIGS. 7A and 7B, it is assumed that noise introduced between approximately the 1,000^{th} frame and approximately the 4,000^{th} frame, and a touch has occurred between approximately the 2,000^{th} frame and approximately the 3,000^{th} frame.

Comparing FIG. 7A with FIG. 7B, it can be seen that noise introduced in the untouched regions in the graph of FIG. 7A, i.e., between approximately the 1,000^{th} frame and approximately the 2,000^{th} frame, and between approximately the 3,000^{th} frame and approximately the 4,000^{th} frame is removed from the same regions in the graph of FIG. 7B. However, it can be seen that some of noise in the touched region of FIG. 7A, i.e., between approximately the 2,000^{th} frame and approximately the 3,000^{th} frame partially exist in the same region in the graph of FIG. 7b as well.

The level of the noise introduced into a touch panel tends to increase as the amplitude of the digital signals S_{D} increases. Thus, if the noise estimation signal S_{N} obtained by calculating the average of the levels of the digital signals S_{D} in the untouched region is subtracted from the digital signals S_{D} in the touched region as it is, some of the noise remains as shown in FIG. 7B.

In order to remove the remaining noise, the noise removal unit 450 may increase the amplitude of the noise estimation signal S_{N} in proportion to the amplitudes of the digital signals S_{D} in the touch region and subtract the increased noise estimation signal S_{N} from the digital signals S_{D} in the touched region, to thereby effectively remove the common noise.

For example, since the level of the digital signal S_{D} acquired from the fifth one Y5 of the second electrodes is greater than the levels of the digital signals S_{D} acquired from the fourth and fifth second electrodes Y4 and Y6 of the second electrodes in FIG. 6A, the level of the noise estimation signal applied to the fifth one Y5 of the second electrodes may be increased more than the levels of the noise estimation signals S_{N} applied to the fourth and fifth second electrodes Y4 and Y6 of the second electrodes.

As set forth above, according to exemplary embodiments of the present disclosure, difference signals are generated by obtaining differences in levels between sensing signals or between digital signals acquired from adjacent electrodes, and an average level of the sensing signals or of the digital signals from which difference signals within a predetermined level section originate is calculated, such that a noise level may be calculated.

While exemplary embodiments have been shown and described above, it will be apparent to those skilled in the art that modifications and variations could be made without departing from the spirit and scope of the present disclosure as defined by the appended claims.

What is claimed is:

1. A touchscreen device, comprising:
a subtraction unit, for all sensing signals acquired from a plurality of electrodes, obtaining differences in levels between the sensing signals acquired from two adjacent electrodes;
a region determination unit determining touched regions and untouched regions based on difference signals generated in the subtraction unit;
an average unit calculating an average of levels of the sensing signals generated in the plurality of electrodes determined as the untouched regions to generate a noise estimation signal; and
a noise removal unit subtracting a level of the noise estimation signal from the levels of the sensing signals.

2. The touchscreen device of claim 1, wherein the region determination unit determines electrodes of the plurality of electrodes from which difference signals within a predetermined level section among the difference signals originate as the untouched regions and determining electrodes of the plurality of electrodes from which difference signals out of the predetermined level section among the difference signals originate as the touched regions.

3. The touchscreen device of claim 2, wherein the predetermined level section is below a first level in a positive direction and above a second level in a negative direction with respect to a zero level.

4. The touchscreen device of claim 1, wherein the level of the noise estimation signal applied to the sensing signals acquired in the touched regions by the noise removal unit is different from that of the untouched region.

5. The touchscreen device of claim 1, wherein the noise removal unit increases the level of the noise estimation signal in proportion to amplitudes of the sensing signals acquired in the touched regions and subtracts the increased level of the noise estimation signal from the levels of the sensing signals acquired in the touched regions.

6. A touchscreen device, comprising:
a panel unit including a plurality of first electrodes and a plurality of second electrodes intersecting the plurality of first electrodes;
a driving circuit unit applying driving signals to the plurality of first electrodes;
a sensing circuit unit acquiring sensing signals from the plurality of second electrodes; and
a control unit generating difference signals by obtaining differences in levels between sensing signals from two adjacent electrodes for all sensing signals acquired from the plurality of second electrodes, and determining whether a touch has occurred based on a noise level calculated based on difference signals within a predetermined level section among the difference signals.

7. The touchscreen device of claim 6, wherein the sensing circuit unit includes a plurality of C-V converters detecting capacitance values generated in intersections of the plurality of first electrodes and the plurality of second electrodes as voltage.

8. The touchscreen device of claim 7, wherein the plurality of C-V converters integrates the capacitance values to detect them as voltage.

9. The touchscreen device of claim 6, wherein the control unit includes:
a signal conversion unit converting sensing signals from the plurality of second electrodes into digital signals;
a noise calculation unit generating difference signals by obtaining differences in levels between the digital signals generated in every two adjacent electrodes of the plurality of second electrodes, and calculating a noise estimation signal based on difference signals within a predetermined level section among the difference signals; and
a noise removal unit subtracting a level of the noise estimation signal from the sensing signals acquired from the plurality of second electrodes.

10. The touchscreen device of claim 9, further comprising:
a touch determination unit determining whether a touch has occurred based on an effective signal generated by the noise removal unit.

11. The touchscreen device of claim 9, wherein the noise calculation unit includes:
a subtraction unit generating difference signals by obtaining differences in levels between digital signals generated in every two adjacent electrodes of the plurality of second electrodes;
a region determination unit determining touched regions and untouched regions based on the difference signals; and
an average unit generating the noise estimation signal by calculating an average of levels of digital signals of the plurality of second electrodes determined as the untouched regions.

12. The touchscreen device of claim 11, wherein the region determination unit determines electrodes of the plurality of second electrodes from which difference signals within a predetermined level section among the difference signals originate as the untouched regions and determining electrodes of the plurality of second electrodes from which difference signals out of the predetermined level section among the difference signals originate as the touched regions.

13. The touchscreen device of claim 9, wherein the noise removal unit applies the noise estimation signal without changing a level thereof to the digital signals acquired in the untouched regions whereas applies the noise estimation signal with the level changed to the digital signals acquired in the touch regions.

14. The touchscreen device of claim 13, wherein the noise removal unit increases the level of the noise estimation signal in proportion to amplitudes of the digital signals acquired in the touched regions and subtracts the increased levels of the noise estimation signal from the digital signals acquired in the touched regions.

15. The touchscreen device of claim 10, wherein the touch determination unit determines at least one of the locations of touches, the amount of touches, and the types of gesture of the touches based on the effective signal.

16. A method of sensing a touch, comprising:
acquiring sensing signals from a plurality of electrodes;
converting the sensing signals into digital signals;
generating difference signals by obtaining differences in levels between digital signals generated in two adjacent electrodes for all of the digital signals generated in the plurality of electrodes;
determining touched regions and untouched regions based on the difference signals;
generating a noise estimation signal by calculating an average of the digital signals generated in the untouched region; and
subtracting a level of the noise estimation signal from the levels of the digital signals.

17. The touchscreen device of claim 16, wherein the determining of the touched regions and the untouched regions includes determining electrodes of the plurality of electrodes from which difference signals within a predetermined level section among the difference signals originate as the untouched regions and determining electrodes of the plurality of electrodes from which difference signals out of the predetermined level section among the difference signals originate as the touched regions.

18. The touchscreen device of claim 16, wherein the subtracting includes applying the noise estimation signal to the digital signals in the untouched regions without changing a level thereof while applying the noise estimation signal to the digital signals in the touch regions with the level thereof changed.

19. The touchscreen device of claim 18, wherein the subtracting includes subtracting the noise estimation signal with the level increased in proportion to amplitudes of the digital signals in the touched regions from the digital signals in the touched regions.
